(19) United States
(12) Patent Application Publication
(10) Pub. No.: US 2007/0268158 A1
(43) Pub. Date: Nov. 22, 2007

(54) System and Method for Reducing Driving Risk With Insight

(75) Inventors: Charlie Gunderson, La Jolla, CA (US); Tom Lafleur, Rancho Santa Fe, CA (US); Doron Lurie, San Diego, CA (US); Bruce Moeller, San Diego, CA (US)

Correspondence Address: PROCOPIO, CORY, HARGREAVES & SAVITCH LLP, 530 B STREET, SUITE 2100, SAN DIEGO, CA, 92101, US

(73) Assignee: DriveCam, Inc., San Diego, CA (US)

(21) Appl. No.: 11/382,328

(22) Filed: May 9, 2006

(51) Int. Cl. G08G 1/01

(52) U.S. Cl. 340/933

(57) ABSTRACT

Systems and methods for scoring individual and groups of drivers and providing vehicle ratings based on captured driving event data are provided. The system comprises an event capture device that records both audio and video of an event. The event data, which includes the audio, video, and other related information, is provided to an evaluation server where it is compiled and analyzed to identify correlations between events, driving behavior, vehicles, circumstances of events, individual drivers, and other event attributes. These correlations are continuously updated and can be weighted in order to provide a comprehensive analysis of the tendencies and characteristics of an individual driver or group of drivers. Event data particular to an individual or group is compiled and analyzed to provide an individualized driver or group score that can be used as a basis to rate the driver or group for customized insurance coverage.

### BACKGROUND

1. Field of the Invention

The present invention generally relates to computer assisted feedback for improving driver performance and more specifically relates to event based analysis and counseling of fleet drivers to reduce risky behavior of fleet drivers.

2. Related Art

Conventional systems for taking risk out of driving are non-existent or impractical today. The current state of the art for predicting the driving safety of individual drivers or groups of drivers operating vehicles under certain circumstances is primitive. Additionally, analysis of identified risky behavior is time consuming and requires a specific skill set not typically found within an organization having a fleet of motor vehicles. Furthermore, there are no systems in place today that can objectively analyze and score driving events to assess the risk of an individual driver or an individual vehicle. Accordingly, what is needed is an efficient system and method for capturing, analyzing, and assessing the risk associated with the driving performance of individual drivers and coaching those individual drivers and providing reports to managers and supervisors to reduce risky driving behaviors.

### SUMMARY

The present invention provides a system and method for computer assisted feedback for taking risk out of driving and more specifically relates to event based analysis for individualized and group driver scoring and vehicle rating. The system comprises an event capture device that records audio, video, and other information that collectively comprise an event. The event data, including the audio, video, and other related information, is provided to an evaluation server where it is stored in a database that aggregates events.

In one embodiment, the events are analyzed and scored and compiled with other event data. Event data may be compiled and analyzed for an individual driver, groups of drivers, individual automobiles and groups of automobiles, where appropriate. Examples of groups may include demographically defined groups (e.g., males age 20-25) or circumstantially defined groups (e.g., night time drivers). Reports for individuals, families, companies, and insurance agents and companies can be created to provide feedback insight and information germane to driver risk.

In another embodiment, aggregate event data in the database of events can be analyzed to identify correlations between events, driving behavior, vehicles, circumstances of events, individual drivers, and other event attributes. These correlations are continuously updated and can be weighted in order to provide a comprehensive analysis of an individual driver resulting in an individualized driver score that can be used as a basis to rate the driver for individualized insurance coverage.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a block diagram illustrating an example event detector in control of a plurality of event capture devices deployed in a vehicle according to an embodiment of the present invention;

FIG. 2 is a block diagram illustrating an example event detector according to an embodiment of the present invention;

FIG. 3 is a block diagram illustrating an example event according to an embodiment of the present invention;

FIG. 4A is a block diagram illustrating an example event traveling from an event detector to an evaluation server according to an embodiment of the present invention;

FIGS. 4B-4D are network diagrams illustrating example routes for an event traveling from an event detector to an evaluation server according to various embodiments of the present invention;

FIG. 5 is a network diagram illustrating an example system for reducing driving risk according to an embodiment of the present invention;

FIG. 6 is a network diagram illustrating an example route for a group of events traveling from an evaluation server to an analysis station according to an embodiment of the present invention;

FIG. 7 is a network diagram illustrating an example route for a coaching session and an event report traveling from an analysis station to an evaluation sever according to an embodiment of the present invention;

FIG. 8 is a network diagram illustrating an example route for a coaching session and an event report traveling from an evaluation sever to a coaching station and a supervisor station according to an embodiment of the present invention;

FIG. 9 is a block diagram illustrating an example evaluation server according to an embodiment of the present invention;

FIG. 10 is a block diagram illustrating an example insight module according to an embodiment of the present invention;

FIG. 11 is a block diagram illustrating an example administrative module according to an embodiment of the present invention;

FIG. 12 is a flow diagram illustrating an example process for providing individual and group driving scores according to an embodiment of the present invention;

FIG. 13 is a block diagram illustrating an example wireless communication device that may be used in connection with various embodiments described herein; and

FIG. 14 is a block diagram illustrating an example computer system as may be used in connection with various embodiments described herein.

### DETAILED DESCRIPTION

Certain embodiments as disclosed herein provide for systems and methods for reducing driving risk that capture driving events and provide those events to an evaluation server where the events are analyzed and reported to management and also compiled into coaching sessions for individuals or groups of drivers to receive in order to demonstrate to them how to avoid risky behaviors while driving. For example, one method as disclosed herein allows for an event capture device to capture an event and send the event via a communication network to an evaluation server. The evaluation server allows an analyst to review the raw event data and create a coaching session directed toward future avoidance of the risky behavior that caused the event. Additionally, the evaluation server compiles reports regarding the events for particular drivers or groups of drivers. The reports are then provided to management by the evaluation server and the coaching sessions are provided to the individual drivers or groups of drivers to improve their future avoidance of risky driving behaviors.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

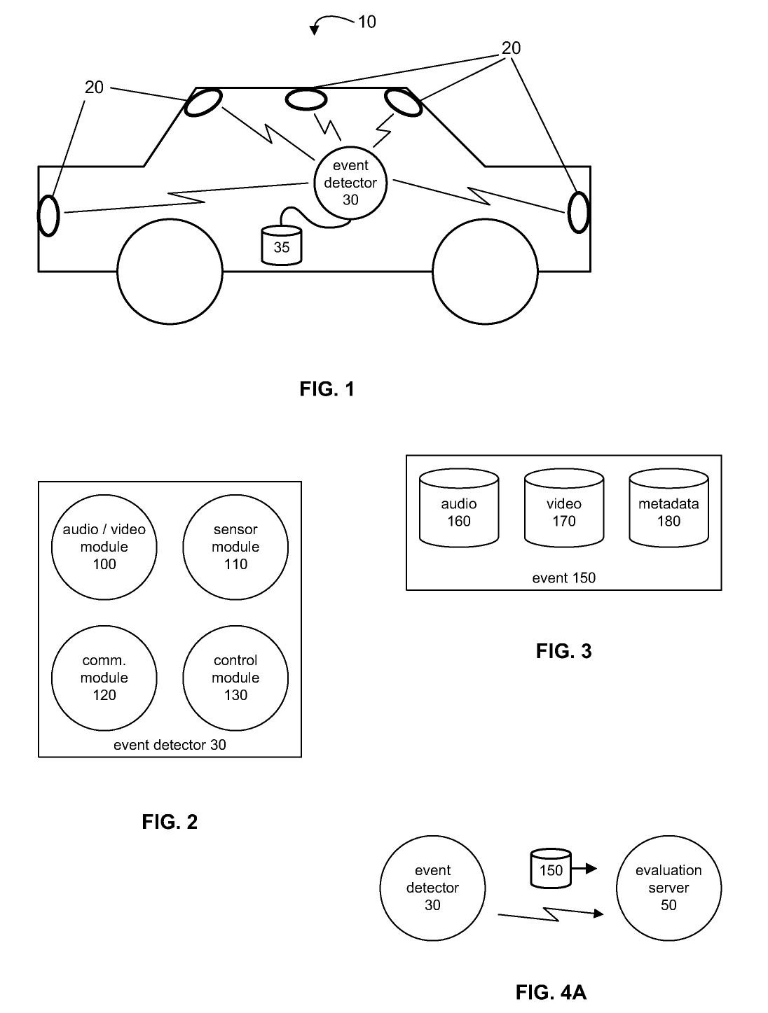

FIG. 1 is a block diagram illustrating an example event detector 30 in control of a plurality of event capture devices 20 deployed in a vehicle 10 according to an embodiment of the present invention. In the illustrated embodiment, the event detector 30 is integrated with the vehicle 10 and is communicatively coupled with the event capture devices 20. The event detector 30 is also configured with data storage 35.

The event detector 30 can be any of a variety of types of computing devices with the ability to execute programmed instructions, receive input from various sensors, and communicate with one or more internal or external event capture devices 20 and other external devices (not shown). An example general purpose computing device that may be employed as all or a portion of an event detector 30 is later described with respect to FIG. 17. An example general purpose wireless communication device that may be employed as all or a portion of an event detector 30 is later described with respect to FIG. 16.

When the event detector 30 identifies an event, the event detector 30 instructs the one or more event capture devices 20 to record pre-event data, during the event data, and post-event data that is then provided to the event detector 30 and stored in the data storage area 35. Events may comprise a variety of situations, including automobile accidents, reckless driving, rough driving, or any other type of stationary or moving occurrence that the owner of a vehicle 10 may desire to know about.

The vehicle 10 may have a plurality of event capture devices placed in various locations around the vehicle 10. An event capture device 20 may comprise a video camera, still camera, microphone, and other types of data capture devices. For example, an event capture device 20 may include an accelerometer that senses changes in speed or direction. Additional sensors and/or data capture devices may also be incorporated into an event capture device 20 in order to provide a rich set of information about a detected event.

The data storage area 35 can be any sort of internal or external, fixed or removable memory device and may include both persistent and volatile memories. The function of the data storage area 35 is to maintain data for long term storage and also to provide efficient and fast access to instructions for applications or modules that are executed by the event capture device 30.

In one embodiment, event detector 30 in combination with the one or more event capture devices 20 identifies an event and stores certain audio and video data along with related information about the event. For example, related information may include the speed of the vehicle when the event occurred, the direction the vehicle was traveling, the location of the vehicle (e.g., from a global positioning system (“GPS”) sensor), and other information from sensors located in and around the vehicle or from the vehicle itself (e.g., from a data bus integral to the vehicle such as an on board diagnostic (“OBD”) vehicle bus). This combination of audio, video, and other data is compiled into an event that can be stored in data storage 35 onboard the vehicle for later delivery to an evaluation server.

FIG. 2 is a block diagram illustrating an example event detector 30 according to an embodiment of the present invention. In the illustrated embodiment, the event detector 30 comprises an audio/video (“AV”) module 100, a sensor module 110, a communication module 120, and a control module 130. Additional modules may also be employed to carry out the various functions of the event detector 30, as will be understood by those having skill in the art.

The AV module 100 is configured to manage the audio and video input from one or more event capture devices and storage of the audio and video input. The sensor module 110 is configured to manage one or more sensors that can be integral to the event detector 20 or external from the event detector 20. For example, an accelerometer may be integral to the event detector 20 or it may be located elsewhere in the vehicle. The sensor module 110 may also manage other types of sensor devices such as a GPS sensor, temperature sensor, moisture sensor, or the like (all not shown).

The communication module 120 is configured to manage communications between the event detector 20 and other devices and modules. For example, the communication module 120 may handle communications between the event detector 20 and the various event capture devices. The communication module 120 may also handle communications between the event detector 20 and a memory device, a docking station, or a server such as an evaluation server. The communication module 120 is configured to communicate with these various types of devices and other types of devices via a direct wire link (e.g., USB cable, firewire cable), a direct wireless link (e.g., infrared, Bluetooth, ZigBee), or a wired or any wireless network link such as a local area network (“LAN”), a wide area network (“WAN”), a wireless wide area network (“WWAN”), an IEEE 802 wireless network such as an IEEE 802.16 (“WiFi”) network, a WiMAX network, satellite network, or a cellular network.

The control module 130 is configured to control the actions or remote devices such as the one or more event capture devices. For example, the control module 130 may be configured to instruct the event capture devices to capture an event and return the data to the event detector when it is informed by the sensor module 110 that certain trigger criteria have been met that identify an event.

FIG. 3 is a block diagram illustrating an example event 150 according to an embodiment of the present invention. In the illustrated embodiment, the event 150 comprises audio data 150, video data 160, and metadata 180. The audio data 150 can be collected from inside the vehicle, outside the vehicle, and may include information from an internal vehicle bus about the baseline noise level of the operating vehicle, if such information is available. Additional information about baseline noise level, radio noise level, conversation noise level, or external noise level may also be included in audio data 160.

Video data 170 may include still images or moving video captured by one or more cameras in various locations in and around the vehicle. Video data 170 may include images or video from inside the vehicle, outside the vehicle, or both. In one particularly advantageous embodiment, still images and moving video that illustrate the entire area inside the vehicle and the entire 360 degree area surrounding the vehicle are captured by a plurality of image capture devices and included in video data 170.

Metadata 180 may include a variety of additional information that is available to the event detector 30 at the time of an event. Such additional data may include, but is not limited to, the velocity and direction of the vehicle, the GPS location of the vehicle, elevation, time, temperature, and vehicle engine and electrical component information, status of vehicle lights and signals, brake operation and position, throttle position, etc. captured from an internal vehicle bus, just to name a few. Additional information may also be included such as the number of occupants in the vehicle, whether seatbelts were fastened, whether airbags deployed, whether evasive maneuvering was attempted as determined by the route of the vehicle prior to the event. The specific identification of the driver may also be included, for example as read by the event detector from a radio frequency identification (“RFID”) badge worn by the driver or integrated with a vehicle key assigned to the driver. As will be understood by those skilled in the art, metadata 180 may include an extremely rich variety of information limited only by the scope and type of information obtained prior to, during, and after an event.

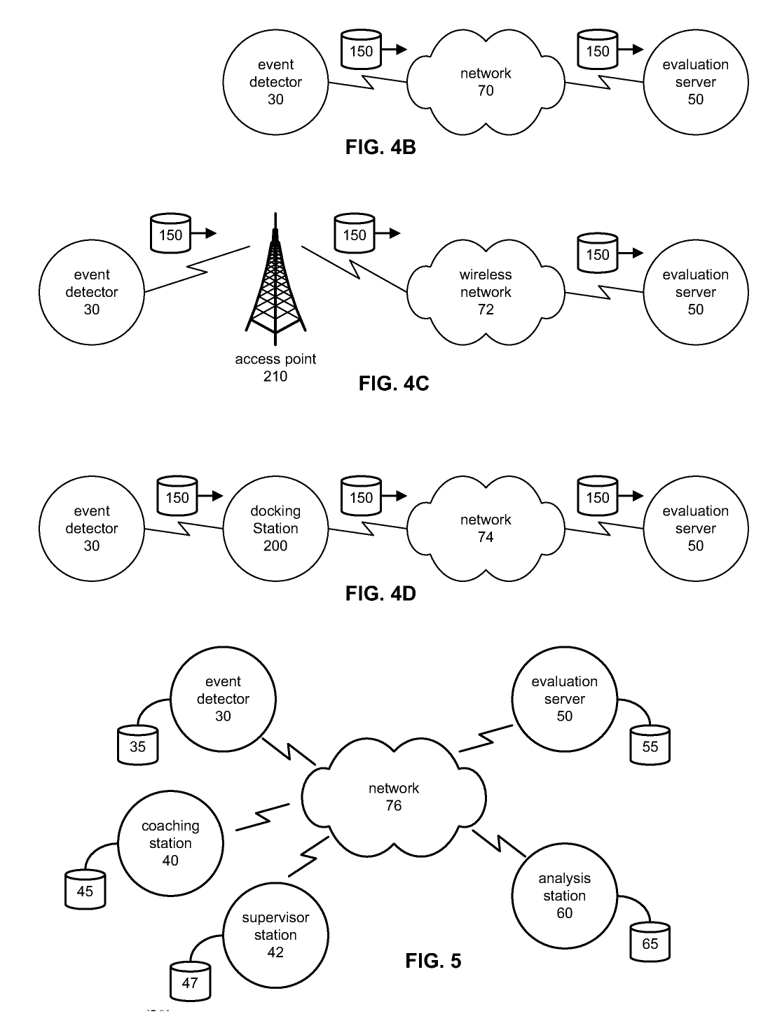

FIG. 4A is a block diagram illustrating an example event 150 traveling from an event detector 30 to an evaluation server 50 according to an embodiment of the present invention. In one embodiment, events such as event 150 are captured by an event detector 30 and stored locally until they are provided to the evaluation server 50. The means by which an event 150 can be provided to the evaluation server 50 can vary. In various embodiments (or in a single embodiment), an event 150 may be provided from event detector 30 to evaluation server 50 by way of a portable media device, a direct wire link, a direct wireless link, an indirect wire link, an indirect wireless link, or any combination of these. Event 150 may be secured by encryption of the event 150 data structure and/or a secure channel between the event detector 30 and the evaluation server 50.

For example, a portable media device may include a USB drive, compact disc, thumb drive, media card, or other similar type of device. A direct wire link may include a USB cable, a firewire cable, an RS-232 cable, or the like. A direct wireless link may include an infrared link, a Bluetooth link, ZigBee link, or an IEEE 802.11 point-to-point link, a WiMAX link, satellite link, or a cellular link, just to name a few. An indirect wired link may include a packet switched or circuit switched network connection configured for conveyance of data traffic. An Ethernet network connection is an example of a packet switched indirect wired link and a dial up modem connection is an example of a circuit switched indirect wired link, both of which may be configured for conveyance of data traffic.

The following FIGS. 4B-4D illustrate various embodiments for providing events to an evaluation server.

FIG. 4B is a network diagram illustrating an example route for an event 150 traveling from an event detector 30 to an evaluation server 50 according to an embodiment of the present invention. In the illustrated embodiment, the event 150 travels over a network 70 from the event detector 30 to the evaluation server 50. The network 70 may comprise any of a variety of network types and topologies and any combination of such types and topologies. For example, the network 70 may comprise a plurality of networks including private, public, circuit switched, packet switched, personal area networks (“PAN”), local area networks (“LAN”), wide area networks (“WAN”), metropolitan area networks (“MAN”), satellite network, or any combination of the these. Network 70 may also include that particular combination of networks ubiquitously known as the Internet.

FIG. 4C is a network diagram illustrating an example route for an event 150 traveling from an event detector 30 to an evaluation server 50 according to an embodiment of the present invention. In the illustrated embodiment, the event 150 travels to a wireless network 72 by way of an access point 210 and then on to the evaluation server 50 via the wireless network 72. The access point 210 may provide access via many different wireless network protocols as will be well understood by those having skill in the art. The wireless network 72 may be a WWAN or a WiFi network. The link between the event detector 30 and the access point 210 may be a short range direct link or a wide range direct link. The access point 210 may be a large radio tower device or a small in-home wireless appliance. The wireless network 72 may include over the air segments and also wired segments. For example, the last mile segments of wireless network 72 may be over the air while internal and back end segments may be wired segments. In one embodiment, the wireless network 72 may provide a wireless interface to the event detector 30 and then have a wired interface on the back end to the Internet, which in turn connects the evaluation server 50.

FIG. 4D is a network diagram illustrating an example route for an event 150 traveling from an event detector 30 to an evaluation server 50 according to an embodiment of the present invention. In the illustrated embodiment, a docking station 200 is disposed between the event detector and the network 74. In such an embodiment, an event 150 may be provided from the event detector 30 to the docking station 200 via a variety of means as described above, including portable media, direct wired or wireless link, and indirect wired or wireless link. The event detector 30 may also be physically coupled with the docking station 200 to convey the event 150 from the event detector 30 to the docking station 200. Once the event 150 is received by the docking station 200, the event is then sent over the network 74 to the evaluation server 50. In the illustrated embodiment, the network 74 may be a wired or wireless network or a combination of the two. The network 74 may also be private or public in whole or in part and may also include the Internet.

FIG. 5 is a network diagram illustrating an example system for driver improvement according to an embodiment of the present invention. In the illustrated embodiment, the system includes an event detector 30, a coaching station 40, a supervisor station 42, an evaluation server 50, and an analysis station 60, each coupled with a data storage area 35, 45, 47, 55, and 65, respectively. Additional event detectors 30, coaching stations 40, supervisor stations 42, evaluation servers 50, and analysis stations 60 may also be included.

The function of the event detector 30 is to identify and capture a plurality of events and send a data structure representing the audio, video, and other data related to the event to the evaluation server 50. The evaluation server maintains the captured events and provides them to the analysis station 60 where the events are reviewed. The analysis station 60 may be configured with certain hardware and software modules that allow an operator to review event data (e.g., audio, video, and metadata) in order to make an analysis related to the event and create summary reports and the like.

After an event is reviewed, it may be discarded, incorporated into a coaching session, flagged for follow up, flagged for inclusion in one or more reports, or otherwise maintained for later coaching, reporting, or analysis. In one embodiment, certain portions of one or more events may be incorporated into a report or a coaching session and then sent back to the evaluation server 50 for storage.

The coaching station 40 is configured to play coaching sessions to a particular driver in order to educate the driver about his or her risky driving behavior and suggest alternative driving techniques that the driver may employ to reduce such risky behavior. The coaching station 40 can access coaching sessions from the evaluation server 50 via the network 76 to view the coaching session. The supervisor station 42 is configured to allow executives, managers, and supervisors to access reports on the evaluation server over network 76 and view coaching sessions and reports regarding driver behavior. In one embodiment, a conventional web browser utility can be used at either the coaching station 40 or the supervisor station 42 to view both reports and coaching stations, thereby making either device a coaching station or a supervisor station based on the type of information that is accessed from the evaluation server.

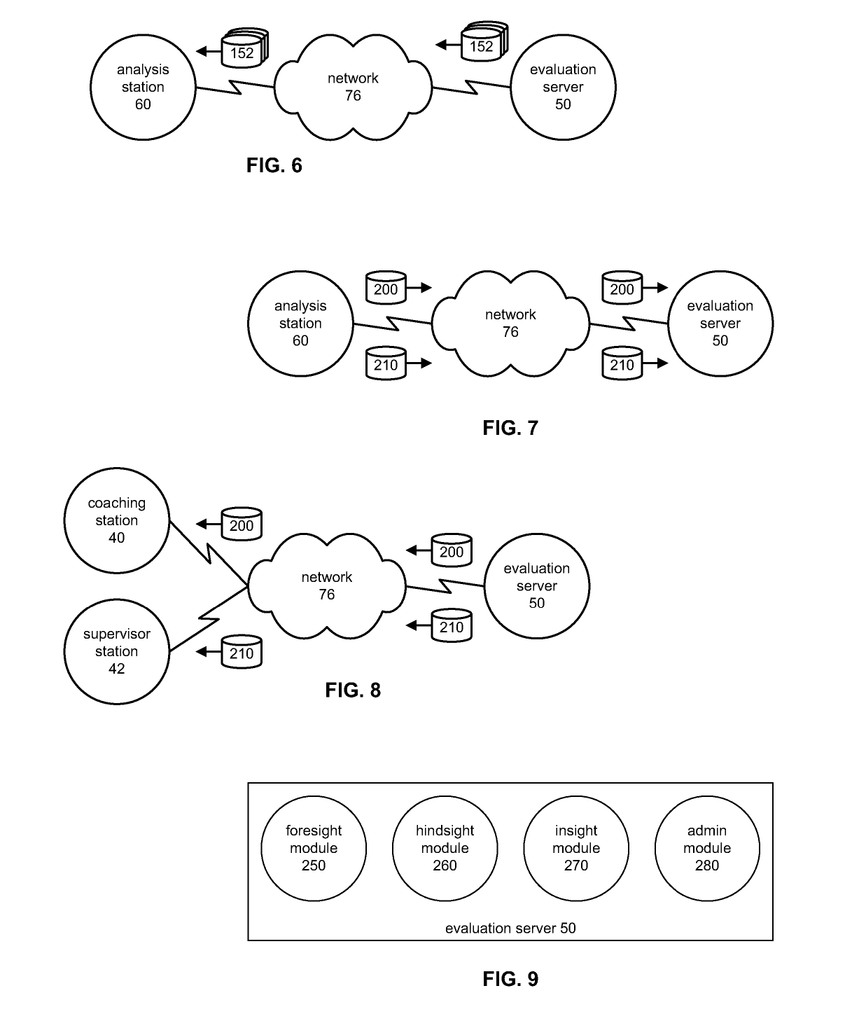

FIG. 6 is a network diagram illustrating an example route for a group of events 152 traveling from an evaluation server to an analysis station according to an embodiment of the present invention. In the illustrated embodiment, the group of events 152 is provided by the evaluation server 50 to the analysis station 60 via the network 76. On the evaluation server, the group of events 152 may be identified by searching for all events that pertain to a particular driver. This may be accomplished by associating each event at the time it is captured with a particular driver. For example, the driver of a vehicle may have a unique identifier and that unique identifier may be included as part of the metadata for each event that is captured while that driver is operating the vehicle. In one embodiment, the driver identifier may be obtained by the event detector by reading an infrared identification device, perhaps incorporated into the driver's identification badge or by receiving the identifier as input when the driver begins the shift, or by reading the identifier from a media card or other wired or wireless device associated with the driver.

Groups of events 152 may also be identified by all events associated with a particular company, a particular shift, a particular supervisor, or other reporting structure or working structure combinations. Such a group of events 152, once provided to the analysis station 60 can then be analyzed by an operator that reviews each event to identify those events that need to be reported or shown to the driver, for example as part of a coaching station.

FIG. 7 is a network diagram illustrating an example route for a coaching session 200 and an event report 210 traveling from an analysis station 60 to an evaluation sever 50 according to an embodiment of the present invention. In the illustrated embodiment, an operator at the analysis station 60 may create a coaching session 200 that is made up of all or a portion of a plurality of events (audio, video, and metadata). The coaching session 200 may also include notes/comments from an operator who analyzed the event data or notes/comments from a supervisor or manager or executive. Such a coaching session 200 may be directed to an individual driver, a shift of drivers, or other classes of drivers for which the session may be beneficial (e.g., night time drivers, truck drivers, drivers of vehicles with trailers, etc.). The coaching session may also be directed to supervisors or managers or executives.

Additionally, the operator may also create a report 210 that is made up of summary information about all notable events. A notable event may be characterized as any event that the vehicle owner wants to know about. In one embodiment, there can be certain variable criteria that each vehicle owner can set in order to determine the risk level for events that are compiled into a report 210. Additionally, a report 210 may be created that includes information about all captured events, whether the event reflects a pothole or an automobile accident.

As shown in the illustrated embodiment, one or more coaching sessions 200 and reports 210 can be provided from the analysis station 60 to the evaluation server 50. These coaching sessions and reports can then be maintained at the evaluation server 50 for later viewing by executives, managers, supervisors, drivers, and the like. Such reports 210 and coaching sessions 200 can also be compiled onto a portable media such as a CD for viewing by new employees during orientation sessions.

FIG. 8 is a network diagram illustrating an example route for a coaching session 200 and an event report 210 traveling from an evaluation sever 50 to a coaching station 40 and a supervisor station 42 according to an embodiment of the present invention. In the illustrated embodiment, the coaching session 200 and report 210 travel to one or more coaching stations 40 and supervisor stations 42 over network 76. Although as shown the report 210 goes to the supervisor station 42 and the coaching session 200 goes to the coaching station 40, reports and coaching sessions can be sent to any remote device for review. In one embodiment, a conventional web browser utility can be used at a remote station to view both reports and coaching stations, thereby making the device both a coaching station and a supervisor station based on the type of information that is accessed from the evaluation server.

FIG. 9 is a block diagram illustrating an example evaluation server 50 according to an embodiment of the present invention. In the illustrated embodiment, the evaluation server 50 comprises a foresight module 250, a hindsight module 260, an insight module 270, and an administrative module 280.

The foresight module 250 is configured to monitor individual driver behavior and objectively score that behavior. The driver score is provided to executives and managers who can use that information to make informed decisions about behavior modification to eliminate or reduce risky behavior of an individual driver. Advantageously, reducing or eliminating risky behavior of a fleet of drivers may have a significant effect on the cost of insurance for the owner of the fleet of vehicles being driven.

The hindsight module 260 is configured to capture and store event data related to accidents, crashes, and other serious driving events in order to document for use by law enforcement in forensic analysis and insurance companies in coverage disputes. Advantageously, the captured event information provides a purely objective reconstruction of what happened prior to, during, and after an event.

The insight module 270 is configured to aggregate event data into a database of driving events and correlate information in the database to identify trends in driving behavior that relate to risk factors. For example, information about the vehicle and its various components, the driver and occupants, the driving conditions, the driving environment, and other useful data can be employed. The insight module 270 is additionally configured to correlate cause and effect relationships between data points and determine the effect of those relationships upon driver safety. The insight module 270 additionally compares these correlations and driver safety trends with historical event information for individual drivers to provide a driver rating or driver score for an individual driver. The driver score can be used by insurance companies to establish individualized insurance rates.

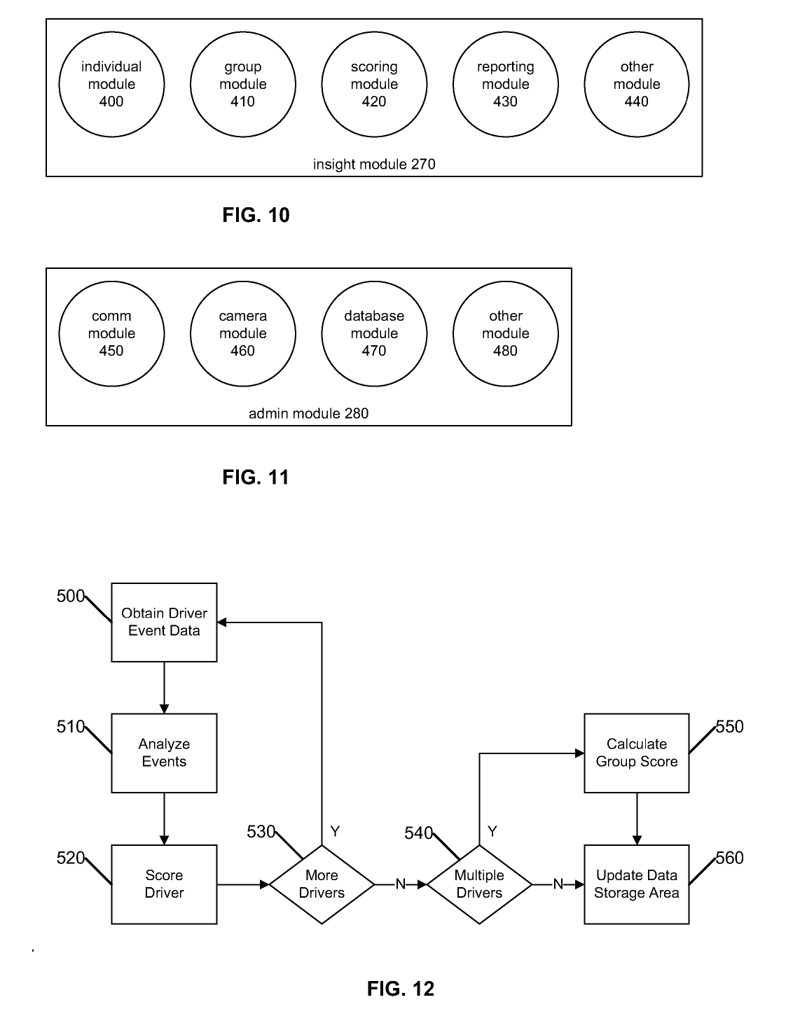

FIG. 10 is a block diagram illustrating an example insight module according to an embodiment of the present invention. In the illustrated embodiment, the insight module 270 comprises an individual module 400, a group module 410, a scoring module 420, a reporting module 380, and an other module 390.

The individual module 400 is configured to analyze event data for an individual and identify individual driving characteristics and tendencies that correlate to certain driving risk factors. For example, the individual module 400 may determine through computer aided analysis of event data for an individual or through input from an operator who has reviewed event data for the individual that the individual driver has a tendency to change lanes without employing a turn signal first. This particular tendency may be correlated to a particular risk factor based on data available in a data storage area accessible to the individual module 400. The individual module 400 can then assign the risk factor to the individual driver. The individual module 400 is also configured to provide the scoring module 420 with information about an individual driver, including, for example, information including the risk factor for being a driver with a tendency to change lanes without using a turn signal.

Similarly, the group module 410 is configured to analyze event data for a group of individual drivers and identify individual and group driving characteristics and tendencies that correlate to certain driving risk factors. Additionally, the group module 410 may be configured to assign relative weights to the risk factors depending on their prevalence to the group as a whole. For example, the group module 410 may determine through computer aided analysis of event data for an individual in a group or through input from an operator who has reviewed event data for the individual that the individual driver has a tendency to change lanes without employing a turn signal first. However, this individual may be the only driver in a group of ten drivers that exhibits this tendency. In one embodiment, this particular tendency as correlated to the risk factor may be reduced by 90 percent when applied to the group as a whole. The group module 410 can then more accurately determine the risk factor for the group of drivers. The individual module 410 is also configured to provide the scoring module 420 with information about a group of drivers, including, for example, information including the reduced risk factor for one driver in the group having the tendency to change lanes without using a turn signal.

The scoring module 420 is configured to receive information from various modules including the individual module 400 and the group module 410 and use that information in conjunction with other information to determine a driving score for an individual driver or a group of drivers. The scoring module 420 is also configured to obtain correlation data, aggregate risk factor data, and other helpful information from a data storage area or a companion local or remote module.

In one embodiment, the scoring module 420 analyzes the various driver tendencies and risk factors and correlates those tendencies and risk factors with aggregate information about driver tendencies and risk factors. Advantageously, the scoring module 420 may be configured to access a database of events and/or related information and analyze such information to normalize the driver tendencies and associated risk factors over a significant population of event data that is continuously collected by the system during operation. Accordingly, the scoring module 420 can calculate an individual driver score or a collective driver score for a group of drivers based on individual driver tendencies and characteristics and other information about the drivers.

In one embodiment, the scoring module 420 is also configured to score vehicles in addition to drivers. Advantageously, the same rich data source of driving events can be mined by the scoring module to arrive at a vehicle score for an individual vehicle, a particular model of vehicle, a certain make of vehicle, or some other grouping of vehicles (e.g., light trucks). Vehicle scoring information can also be used by the scoring module 420 when calculating an individual or group driving score.

Reporting module 430 is configured to compile reports based on individual driver scores, aggregate driver scores, and underlying event data. Reports may be compiled for an individual driver, a particular shift, all day time drivers, all night time drivers, all twilight drivers (morning and evening), all drivers of particular vehicle types, and other groupings such as a family. These reports can be provided to the individual drivers, insurance agents, insurance companies, car companies, governmental entities and others. Advantageously, reports can be used by individuals or companies for obtaining estimates on insurance rates for a particular individual or group.

In one embodiment, reports can be targeted for individual drivers, groups of drivers such as a particular shift with specific individuals or a particular shift such as a night driving shift, groups of drivers such as a family—including the group in conjunction with the specific vehicles that are driver by the group and the relative percentage of time each individual is driving each vehicle. These reports can advantageously be extremely granular to allow for very specific and accurate calculation of the driving risk for the individual or group so that insurance companies can set the price of insurance coverage accordingly. The reports may be used for a variety of purposes, including purchasing insurance, hiring and firing decisions for a company, vehicle allotment amongst family members, etc.

Additional functionality may also be included in the insight module 270, as indicated by the other module 440. The other module 440 may be configured to perform a variety of tasks, including but not limited to: scoring driver behavior before during and after the accident, preparing alternative driver scores based upon variable criteria, scoring vehicles, calculating multiple driver scores for the same vehicle type, e.g., for a shift of drivers, aggregating multiple driver scores over multiple vehicles, e.g., for a family, integration and assimilation of driver score data based on event data into a common data storage area; and mining of driver score data and event data from the data storage area, just to name a few.

FIG. 11 is a block diagram illustrating an example administrative module 280 according to an embodiment of the present invention. In the illustrated embodiment, the administrative module 280 comprises a communication module 450, an event detector module 460, a database module 470, and an other module 480.

In one embodiment, the communication module 450 is configured to manage communications between the evaluation server 50 and the various stations and event detectors that are part of the system for reducing driving risk. For example, the communication module 450 may manage communications with individual event detectors, analysis stations, coaching stations, supervisor stations, docking stations, and the like.

Additionally, communication module 450 may also manage communications between the various modules of the evaluation server 50. For example, communications between the foresight, hindsight, and insight modules may be managed by communication module 450. The communication module 450 is configured to manage wireless and wired communications and send and receive communications over a wired or wireless network.

The communication module 450 is configured to send and receive communications to and from an event detector device, either directly or indirectly. For example, communications with an event detector device may take place through a docking station or a server that aggregates event data from multiple event detector devices before sending the event data to the evaluation server.

The event detector module 460 is configured to manage individual and groups of event detectors. In one embodiment, the event detector module 460 may manage software versions that are resident on individual event detector devices so that the overall system may be kept up to date with respect to the versions of software deployed in the field.

Event detector module 460 may also track the individual event detectors that have provided event data or otherwise reported back to the evaluation server during a given time period. For example, event detector module 460 may track those event detectors that have reported in during each day and provide summary reports so that managers and supervisors can determine if event data from each vehicle in use is being sent to the evaluation server. In one embodiment, the event detector module 460 may attempt to contact an individual event detector in order to determine the status of the event detector. Advantageously, the evaluation server can determine the efficacy of the overall system by periodic confirmation of the status of each event detector. If the event detector module 460 determines that a particular event detector is not working properly, then that event detector may be identified as needing service or replacement.

Database module 470 is configured to manage a database of information related to reducing driving risk. For example, event data, coaching sessions, and reports can be maintained in a data storage area by database module 470. Additionally, related information from sources other than event detectors and analysis stations may also be managed by the database module 470. For example, weather information can be obtained from third party sources and stored to provide objective information about the weather conditions during a particular event. Additional information may also include traffic congestion information and smog/visibility information. Other beneficial information may also be included and managed by database module 470.

Additional functionality may also be included in the administrative module 280, as indicated by the other module 480. The other module 480 may be configured to perform a variety of tasks, including but not limited to: obtaining related information (e.g., road conditions, traffic conditions, weather, etc.), providing reports about event detector status, and tracking overall system performance and facilitating system maintenance when appropriate.

FIG. 12 is a flow diagram illustrating an example process for providing individual and group driving scores according to an embodiment of the present invention. The illustrated process can be carried out by a system such as that previously described with respect to FIG. 5, for example, by a scoring module associated with an insight module on an evaluation server or analysis station. The process may also be applied to vehicles rather than drivers to arrive at a vehicle score.

Initially, in step 500 the scoring module obtains event data for a driver or vehicle, depending on the entity being scored. The rest of the description for this process will focus on a driver being scored for simplicity. The event data may be obtained from a data storage area accessible to the scoring module or provided via a network connection and a companion module. Once the event data has been obtained for the driver, the events are analyzed to identify driver tendencies and characteristics and correlate those with related risk factors, as shown in step 510. As a result of the analysis of the event data, in step 520 the scoring module can determine a score for the individual driver. In an embodiment where a group of drivers is being scored, as determined in step 530, the process loops back to step 500 where event data is obtained for the next driver in the group.

Next, in step 540 if there are no more drivers to score, the scoring module determines if only a single driver is being scored. If multiple drivers are being scored, then in step 550 the scoring module calculates a group scored based on aggregate driver scores. In one embodiment, the group score can be a simple average of driver scores. Alternatively, the group score can be based on relative weights of risk factors and related tendencies and characteristics to provide a more granular and accurate group driving score.

In step 560, if only one driver was being scored or after the group score has been calculated, the scoring module can update a data storage area with the scoring information and related data. Advantageously, scoring information from the data storage area can be used by the scoring module in calculating future driver scores. For example, aggregate driver scores over time may be employed to develop a baseline driver score as related to certain driver characteristics and tendencies. Such average scores may be used by the system for quick comparisons based on major event data to pre-score a particular driver and thereby, for example, determine if the individual driver is worth a detailed analysis as a potential insured. Other significant advantages of maintaining and updating driver score information over time will be understood by those skilled in the art.

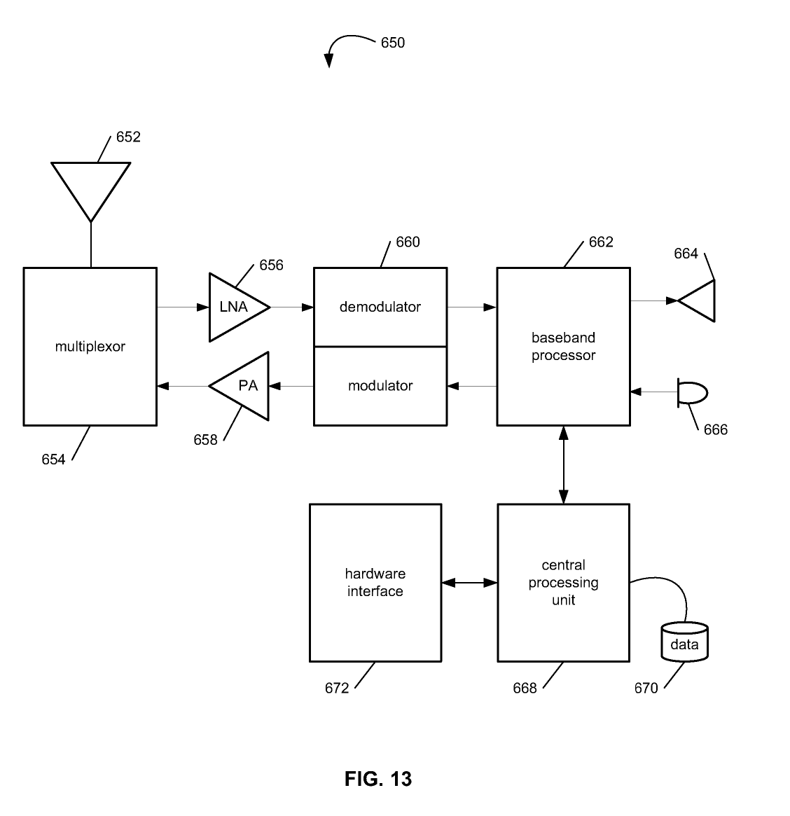

FIG. 13 is a block diagram illustrating an exemplary wireless communication device 650 that may be used in connection with the various embodiments described herein. For example, the wireless communication device 650 may be used in conjunction with an event detector previously described with respect to FIG. 1, or an evaluation server, analysis station, coaching station, or supervisor station previously described with respect to FIG. 2. However, other wireless communication devices and/or architectures may also be used, as will be clear to those skilled in the art.

In the illustrated embodiment, wireless communication device 650 comprises an antenna 652, a multiplexor 654, a low noise amplifier (“LNA”) 656, a power amplifier (“PA”) 658, a modulation circuit 660, a baseband processor 662, a speaker 664, a microphone 666, a central processing unit (“CPU”) 668, a data storage area 670, and a hardware interface 672. In the wireless communication device 650, radio frequency (“RF”) signals are transmitted and received by antenna 652. Multiplexor 654 acts as a switch, coupling antenna 652 between the transmit and receive signal paths. In the receive path, received RF signals are coupled from a multiplexor 654 to LNA 656. LNA 656 amplifies the received RF signal and couples the amplified signal to a demodulation portion of the modulation circuit 660.

Typically modulation circuit 660 will combine a demodulator and modulator in one integrated circuit (“IC”). The demodulator and modulator can also be separate components. The demodulator strips away the RF carrier signal leaving a base-band receive audio signal, which is sent from the demodulator output to the base-band processor 662.

If the base-band receive audio signal contains audio information, then base-band processor 662 decodes the signal and converts it to an analog signal. Then the signal is amplified and sent to the speaker 664. The base-band processor 662 also receives analog audio signals from the microphone 666. These analog audio signals are converted to digital signals and encoded by the base-band processor 662. The base-band processor 662 also codes the digital signals for transmission and generates a base-band transmit audio signal that is routed to the modulator portion of modulation circuit 660. The modulator mixes the base-band transmit audio signal with an RF carrier signal generating an RF transmit signal that is routed to the power amplifier 658. The power amplifier 658 amplifies the RF transmit signal and routes it to the multiplexor 654 where the signal is switched to the antenna port for transmission by antenna 652.

The baseband processor 662 is also communicatively coupled with the central processing unit 668. The central processing unit 668 has access to a data storage area 670. The central processing unit 668 is preferably configured to execute instructions (i.e., computer programs or software) that can be stored in the data storage area 670. Computer programs can also be received from the baseband processor 662 and stored in the data storage area 670 or executed upon receipt. Such computer programs, when executed, enable the wireless communication device 650 to perform the various functions of the present invention as previously described.

In this description, the term “computer readable medium” is used to refer to any media used to provide executable instructions (e.g., software and computer programs) to the wireless communication device 650 for execution by the central processing unit 668. Examples of these media include the data storage area 670, microphone 666 (via the baseband processor 662), antenna 652 (also via the baseband processor 662), and hardware interface 672. These computer readable mediums are means for providing executable code, programming instructions, and software to the wireless communication device 650. The executable code, programming instructions, and software, when executed by the central processing unit 668, preferably cause the central processing unit 668 to perform the inventive features and functions previously described herein.

The central processing unit is also preferably configured to receive notifications from the hardware interface 672 when new devices are detected by the hardware interface. Hardware interface 672 can be a combination electromechanical detector with controlling software that communicates with the CPU 668 and interacts with new devices.

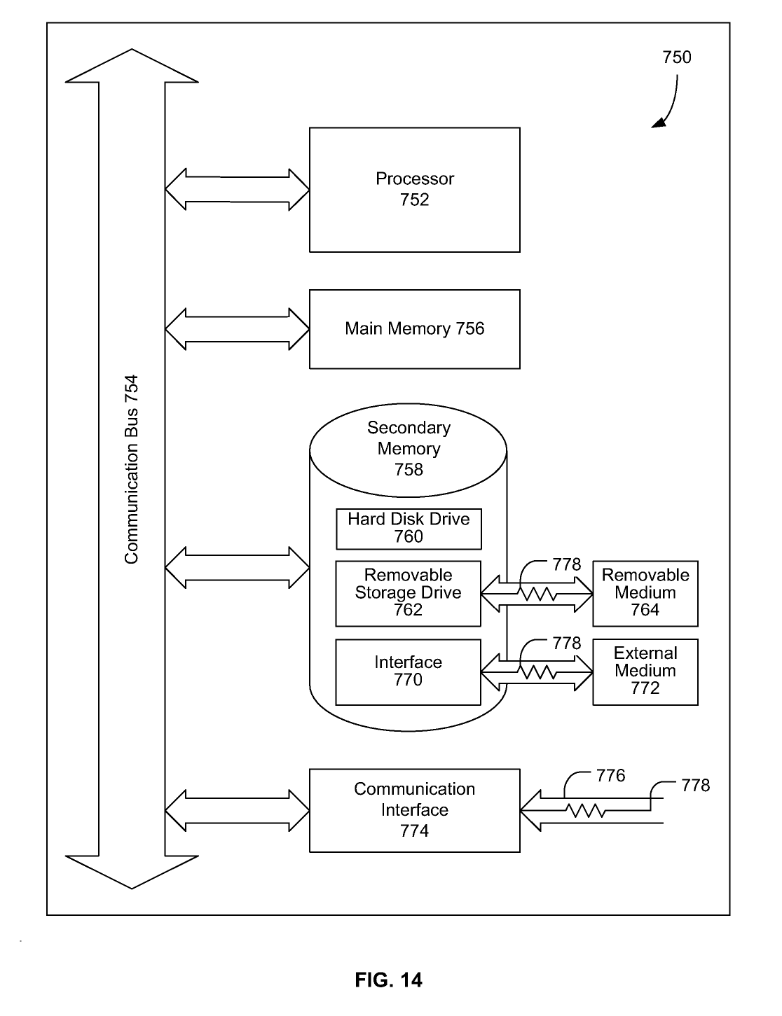

FIG. 14 is a block diagram illustrating an exemplary computer system 750 that may be used in connection with the various embodiments described herein. For example, the computer system 750 may be used in conjunction with an event detector previously described with respect to FIG. 1, or an evaluation server, analysis station, coaching station, or supervisor station previously described with respect to FIG. 2. However, other computer systems and/or architectures may be used, as will be clear to those skilled in the art.

The computer system 750 preferably includes one or more processors, such as processor 752. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 752.

The processor 752 is preferably connected to a communication bus 754. The communication bus 754 may include a data channel for facilitating information transfer between storage and other peripheral components of the computer system 750. The communication bus 754 further may provide a set of signals used for communication with the processor 752, including a data bus, address bus, and control bus (not shown). The communication bus 754 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, mini PCI express, or standards promulgated by the Institute of Electrical and Electronics Engineers (“IEEE”) including IEEE 488 general-purpose interface bus (“GPIB”), IEEE 696/S-100, and the like.

Computer system 750 preferably includes a main memory 756 and may also include a secondary memory 758. The main memory 756 provides storage of instructions and data for programs executing on the processor 752. The main memory 756 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 758 may optionally include a hard disk drive 760 and/or a removable storage drive 762, for example a floppy disk drive, a magnetic tape drive, a compact disc (“CD”) drive, a digital versatile disc (“DVD”) drive, etc. The removable storage drive 762 reads from and/or writes to a removable storage medium 764 in a well-known manner. Removable storage medium 764 may be, for example, a floppy disk, magnetic tape, CD, DVD, memory stick, USB memory device, etc.

The removable storage medium 764 is preferably a computer readable medium having stored thereon computer executable code (i.e., software) and/or data. The computer software or data stored on the removable storage medium 764 is read into the computer system 750 as electrical communication signals 778.

In alternative embodiments, secondary memory 758 may include other similar means for allowing computer programs or other data or instructions to be loaded into the computer system 750. Such means may include, for example, an external storage medium 772 and an interface 770. Examples of external storage medium 772 may include an external hard disk drive or an external optical drive, or and external magneto-optical drive.

Other examples of secondary memory 758 may include semiconductor-based memory such as programmable read-only memory (“PROM”), erasable programmable read-only memory (“EPROM”), electrically erasable read-only memory (“EEPROM”), or flash memory. Also included are any other removable storage units 772 and interfaces 770, which allow software and data to be transferred from the removable storage unit 772 to the computer system 750.

Computer system 750 may also include a communication interface 774. The communication interface 774 allows software and data to be transferred between computer system 750 and external devices (e.g. printers), networks, or information sources. For example, computer software or executable code may be transferred to computer system 750 from a network server via communication interface 774. Examples of communication interface 774 include a modem, a network interface card (“NIC”), a communications port, a PCMCIA slot and card, an infrared interface, and an IEEE 1394 fire-wire, just to name a few.

Communication interface 774 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 774 are generally in the form of electrical communication signals 778. These signals 778 are preferably provided to communication interface 774 via a communication channel 776. Communication channel 776 carries signals 778 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software) is stored in the main memory 756 and/or the secondary memory 758. Computer programs can also be received via communication interface 774 and stored in the main memory 756 and/or the secondary memory 758. Such computer programs, when executed, enable the computer system 750 to perform the various functions of the present invention as previously described.

In this description, the term “computer readable medium” is used to refer to any media used to provide computer executable code (e.g., software and computer programs) to the computer system 750. Examples of these media include main memory 756, secondary memory 758 (including hard disk drive 760, removable storage medium 764, and external storage medium 772), and any peripheral device communicatively coupled with communication interface 774 (including a network information server or other network device). These computer readable mediums are means for providing executable code, programming instructions, and software to the computer system 750.

In an embodiment that is implemented using software, the software may be stored on a computer readable medium and loaded into computer system 750 by way of removable storage drive 762, interface 770, or communication interface 774. In such an embodiment, the software is loaded into the computer system 750 in the form of electrical communication signals 778. The software, when executed by the processor 752, preferably causes the processor 752 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A method for reducing driving risk, comprising:
capturing a driving event at an event capture device coupled with a vehicle, the driving event comprising profile information including an identifier that identifies the driver of the vehicle during the driving event;
providing the driving event to an evaluation server;
scoring the driving event based on driver insurance risk factors;
associating the driving event score with the driver identifier; and
combining a plurality of driving event scores associated with a driver identifier to generate an overall driver risk factor score.

2. The method of claim 1, further comprising combining a plurality of overall driver risk factor scores to create an average risk factor score.

3. The method of claim 2, wherein the average risk factor score is for drivers at a particular company.

4. The method of claim 3, wherein the average risk factor score is for a particular subset of drivers.

5. The method of claim 4, wherein the particular subset of drivers is identified by shift.

6. The method of claim 4, wherein the particular subset of drivers is identified by time of day.

7. The method of claim 6, wherein the time of day comprises night time.

8. The method of claim 6, wherein the time of day comprises twilight.

9. The method of claim 1, further comprising providing the overall driver risk factor score to an employer.

10. The method of claim 2, further comprising providing the average risk factor score to an employer.

11. The method of claim 2, further comprising aggregating a plurality of driver scores to create a group score.

12. The method of claim 2, wherein the average risk factor score is for a family.

13. A system for reducing risk in driving, comprising:
an event detector coupled with a vehicle, the event detector configured to capture a driving event in response to a trigger, the driving event comprising profile information including an identifier that identifies the driver of the vehicle during the driving event;
a communication link configured to convey the driving event from the event detector to an evaluation server; and
an evaluation server comprising a scoring module configured to analyze the driving event data and create a driver risk factor score.

14. The system of claim 13, wherein the communication link is a wired network.

15. The system of claim 14, wherein the wired network comprises a private network.

16. The system of claim 14, wherein the wired network comprises a public network.

17. The system of claim 13, wherein the communication link is a wireless network.

18. The system of claim 17, wherein the wireless network comprises a ZigBee link.

19. The system of claim 17, wherein the wireless network comprises a Bluetooth link.
